(19) United States
(12) Patent Application Publication
(10) Pub. No.: US 2017/0131400 A1
(43) Pub. Date: May 11, 2017

(54) ROAD-SURFACE DETECTING SYSTEM AND VEHICLE

(71) Applicant: Leauto Intelligent Technology (BEIJING) Co. Ltd., Beijing (CN)

(72) Inventor: BingLin FENG, Beijing (CN)

(73) Assignee: Leauto Intelligent Technology (BEIJING) Co. Ltd., Beijing (CN)

(21) Appl. No.: 14/973,713

(22) Filed: Dec. 17, 2015

(30) Foreign Application Priority Data
Nov. 9, 2015 (CN) 2015107583778

(51) Int. Cl. G01S 13/89; G01S 19/46; G01C 21/36; G05D 1/02; G01C 21/32

(52) U.S. Cl. CPC G01S 13/89; G05D 1/0278; G01C 21/32; G01C 21/3694; G01S 19/46

(57) ABSTRACT

The present disclosure provides aroad-surface detecting system and vehicle. The road-surface detecting system may include an anti-knocking radar system and a control system, wherein the anti-knocking radar system may be configured to measure distance data for the distance from the chassis of the vehicle and the road surface and transmit the distance data to the control system, and the control system may be configured to determine that the road is a bumpy road surface if change of the distance data is more than a preset distance changing value.The road-surface detecting system provided by the present disclosure may reduce the detecting cost by detecting the bumping conditions of the road surface on which the vehicle is currently riding by the anti-knocking radar system and control system mounted on the vehicle.

### CROSS-REFERENCE TO RELATED APPLICATIONS

This application claims priority to Chinese Patent Application No. 201510758377.8, with the title of “ [symbol] ” (Road-Surface Detecting System and Vehicle), filed on Nov. 9, 2015, which is hereby incorporated by reference in its entirety.

### TECHNICAL FIELD

The present disclosure is related to a field of vehicle technique, and more particularly to aroad-surface detecting system and vehicle.

### BACKGROUND

With the improvement of people's life, vehicles become more and more popular, and the comfort and safety in vehicle driving become more important

In the related art, the bumping degree during riding on the road of vehicle may be detected by a plurality of sensor on the road, and thereby the bumping conditions for the road on which the vehicle is riding may be determined so that it is possible for the vehicle (especially unmanned vehicle) to avoid bumpy road during the next riding.

However, in the related art, it is necessary to provide a plurality of sensors during the road detecting, and thus the detecting cost may be high.

### SUMMARY

The embodiments of the present disclosure may provide aroad-surface detecting system and vehicle, so as to reduce the detecting cost.

To achieve the above object, the embodiment of the present disclosure may provide the following technical solutions.

In one aspect, the embodiment of the present disclosure may provide a road-surface detecting system including an anti-knocking radar system and a control system, wherein the anti-knocking radar system may be configured to measure distance data for the distance from the chassis of the vehicle and the road surface and transmit the distance data to the control system, and the control system may be configured to determine that the road is a bumpy road surface if change of the distance data is more than a preset distance changing value.

In another aspect, the embodiment of the present disclosure may provide a vehicle including the road-surface detecting system described above.

The road-surface detecting system provided by the present disclosure may reduce the detecting cost by detecting the bumping conditions of the road surface on which the vehicle is currently riding by the anti-knocking radar system and control system mounted on the vehicle.

### BRIEF DESCRIPTION OF THE DRAWINGS

FIG. 1 is a structural diagram of an embodiment of the road-surface detecting system provided by the present disclosure;

FIG. 2 is a structural diagram of another embodiment of the road-surface detecting system provided by the present disclosure;

FIG. 3 is a structural diagram of another embodiment of the road-surface detecting system provided by the present disclosure;

FIG. 4 is a structural diagram of another embodiment of the road-surface detecting system provided by the present disclosure;

FIG. 5 is a structural diagram of another embodiment of the road-surface detecting system provided by the present disclosure; and

FIG. 6 is a structural diagram of an embodiment of the vehicle provided by the present disclosure.

### DESCRIPTION OF THE EMBODIMENTS

In the following, description in detail would be made on the road-surface detecting system and vehicle of the embodiments of the present disclosure in connection with the drawings.

### First Embodiment

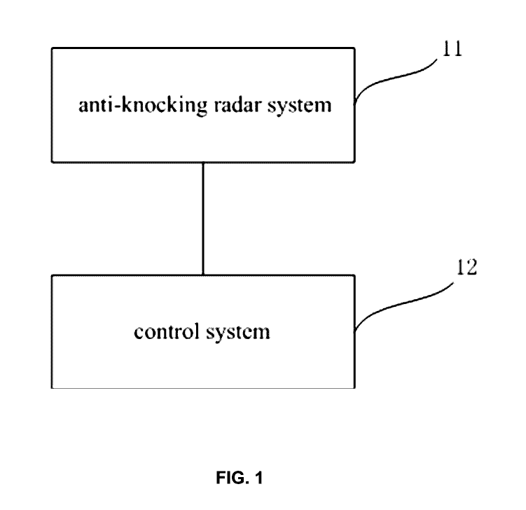

FIG. 1 is a structural diagram of an embodiment of the road-surface detecting system provided by the present disclosure. The road-surface detecting system of the embodiment of the present disclosure may be applicable to various kinds of vehicles. As shown in FIG. 1, the road-surface detecting system of the embodiment of the present disclosure may include an anti-knocking radar system 11 and a control system 12.

The anti-knocking radar system 11 may be configured to measure distance data for the distance from the chassis of the vehicle and the road surface and transmit the distance data to the control system 12.

The control system 12 may be configured to determine that the road surface is a bumpy road surface if change of the distance data is more than a preset distance changing value.

More particularly, when a vehicle is riding on a normal road surface, the distance data for the distance between the chassis of the vehicle and the road surface may not fluctuate. On the other hand, when a vehicle is riding on a bumpy road surface, the distance data for the distance between the chassis of the vehicle and the road surface may fluctuate drastically and quickly. Therefore, it is possible to measure the the distance data for the distance between the chassis of the vehicle and the road surface in real-time by the anti-knocking radar system, and transmit the measured distance data to the control system 12. The control system 12 may determine the road surface is a bumpy road surface according to whether the received distance data changes and whether or not the change may be more than a preset distance changing value. The control system 12 may determine that the road surface is a bumpy road surface if change of the distance data is more than a preset distance changing value, and otherwise the control system 12 may determine that the road surface is a normal road surface. The anti-knocking radar system 11 may be standard equipment for middle or top class vehicle and therefore it may be unnecessary to mount any additional detecting devices and the detecting cost may be reduced. More particularly, the preset distance changing value may be set to any value in a range of 5-15 cm. For example, the preset distance changing value may be set to 10 cm.

The road-surface detecting system provided by the present disclosure may reduce the detecting cost by detecting the bumping conditions of the road surface on which the vehicle is currently riding by the anti-knocking radar system and control system mounted on the vehicle.

### Second Embodiment

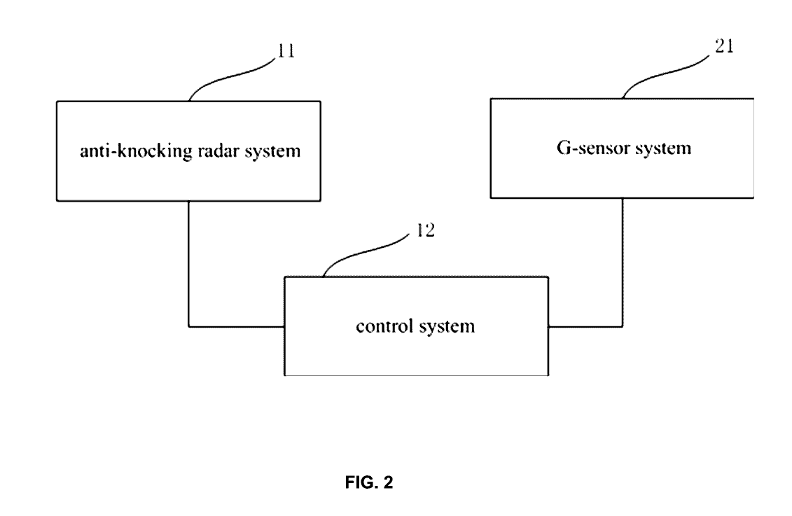

FIG. 2 is a structural diagram of another embodiment of the road-surface detecting system provided by the present disclosure. The road-surface detecting system of the embodiment of the present disclosure may be applicable to various kinds of vehicles. As shown in FIG. 2, the road-surface detecting system of the embodiment of the present disclosure may be an implementation for the road-surface detecting system of the embodiment shown in FIG. 1, and thus may additionally include a G-sensor (Gravity-Sensor) system 21 on basis of embodiment shown in FIG. 1.

The G-sensor system 21 may be configured to detect the riding azimuth data of the vehicle and transmit the riding azimuth data to the control system 21.

Accordingly, the control system 12 may be further configured to determine that the road surface is a bumpy road surface if change of the riding azimuth data is more than a preset riding azimuth data and change of the distance data is more than a preset distance changing value.

More particularly, considering when there is a case happens, for example, tires are broken or the vehicle is passing over a deceleration zone when the vehicle is riding on a normal road, a misjudgment may occur if the determination on whether or not the road surface is a bumpy road surface only depends on the change of the distance data for the distance from the chassis of the vehicle and the road surface. A detection on the riding azimuth of the vehicle may be added considering that there may be drastically swaying and changing of riding azimuth when the vehicle is riding on a bumpy road surface, so as to exclude the misjudgment caused by change of the distance data for the distance from the chassis of the vehicle and the road surface when there is a case happens, for example, tires are broken or the vehicle is passing over a deceleration zone when the vehicle is riding on a normal road. The principle may be described as follows. The anti-knocking system 11 may measure the distance data for the distance from the chassis of the vehicle in real-time and the road surface and transmit the measured distance data to the control system 12.The G-Sensor system 12 may detect the riding azimuth data of the vehicle in real-time and transmit the riding azimuth data to the control system 12. The control system 12 may determine that the road surface is a bumpy road surface according to whether or not the received distance data changes and whether or not the change is more than a preset distance changing value and according to whether or not the received riding azimuth data changes and whether or not the change is more than a preset riding azimuth changing value. Otherwise, it can be determined that the road surface is a non-bumpy road surface, i.e., a normal road surface. The anti-knocking radar system 11 and the G-sensor system 21 may be standard equipments for middle or top class vehicle and therefore it may be unnecessary to mount any additional detecting devices and the detecting cost may be reduced. More particularly, the preset distance changing value may be set to any value in a range of 5-15 cm. For example, the preset distance changing value may be set to 10 cm. The preset riding azimuth changing value may be set to any value in a range of 10-20 degree. For example, the preset riding azimuth changing value may be set to 15 degrees.

Furthermore, the control system 12 may be further configured to transmit the information on road surface to the navigation digital map system for marking, if it is determined that the road surface is a dumpy road surface, so that the navigation digital map system may avoid the bumpy road automatically when the vehicle (especially unmanned vehicle) performs road planning for the next time.

The road-surface detecting system provided by the present disclosure may reduce the detecting cost by detecting the bumping conditions of the road surface on which the vehicle is currently riding by the anti-knocking radar system, G-sensor system, and control system mounted on the vehicle.

### Third Embodiment

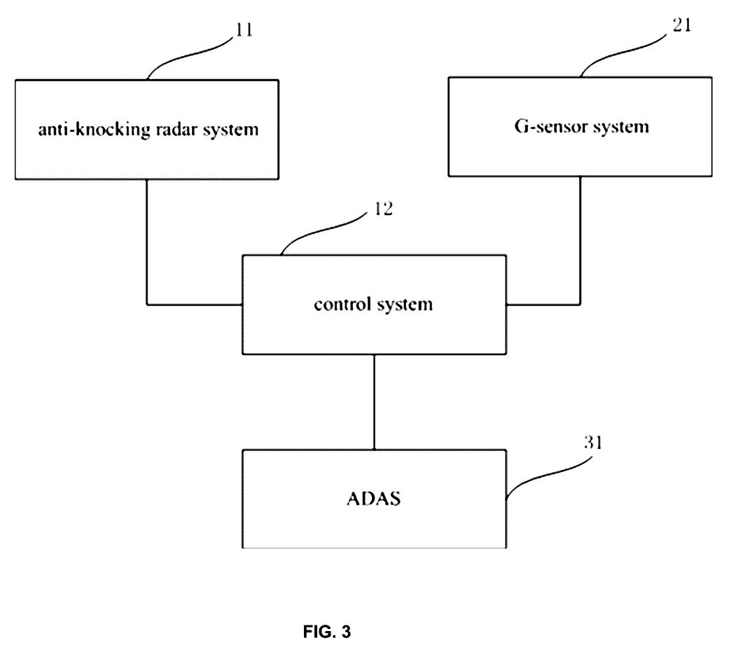

FIG. 3 is a structural diagram of another embodiment of the road-surface detecting system provided by the present disclosure. The road-surface detecting system of the embodiment of the present disclosure may be applicable to various kinds of vehicles. As shown in FIG. 3, the road-surface detecting system of the embodiment of the present disclosure may be an implementation for the road-surface detecting system of the embodiment shown in FIG. 2, and thus may additionally include an ADAS (Advance Driver Assistant System) 31 on basis of embodiment shown in FIG. 2.

The ADAS 31 may be configured to detect ADAS data of the vehicle and transmit the ADAS data to the control system 12.

Correspondingly, the control system 12 may be further configured to determine whether or not the vehicle is in a lane-switching or corner overtaking state according to ADAS data, and determine that the road surface is a bumpy road surface if change of the riding azimuth data is more than a preset riding azimuth data, the vehicle is not in a lane-switching or corner overtaking state and change of the distance data is more than a preset distance changing value.

More particularly, considering the riding azimuth of the vehicle may change when the vehicle is switching lane or making corner overtaking when the vehicle is riding on a normal road, adetection on whether or not the vehicle is in a lane-switching or corner overtaking state, so as to exclude the misjudgment caused by change of the riding azimuth when the vehicle is switching lane or making corner overtaking when the vehicle is riding on a normal road. The principle may be described as follows. The anti-knocking system 11 may measure the distance data for the distance from the chassis of the vehicle in real-time and the road surface and transmit the measured distance data to the control system 12.The G-Sensor system 12 may detect the riding azimuth data of the vehicle in real-time and transmit the riding azimuth data to the control system 12. The ADAS 31 may detect ADAS data of the vehicle in real-time and transmit the ADAS data to the control system 12. The control system 12 may determine whether or not the vehicle is in a lane-switching or corner overtaking state according to ADAS data. The control system 12 may determine whether or not the road surface is a bumpy road surface according to whether or not the received distance data changes and whether or not the change is more than a preset distance changing value and according to whether or not the received riding azimuth data changes and whether or not the change is more than a preset riding azimuth changing value when the vehicle is not in a lane-switching or corner overtaking state. The control system 12 may determine that the road surface is a bumpy road surface when the change of the received distance data is more than a preset distance changing value and the change of the received riding azimuth data is more than a preset riding azimuth changing value. Otherwise, it can be determined that the road surface is a non-bumpy road surface, i.e., a normal road surface. The anti-knocking radar system 11, the G-sensor system 21, and ADAS 31 may be standard equipments for middle or top class vehicle and therefore it may be unnecessary to mount any additional detecting devices and the detecting cost may be reduced. More particularly, the preset distance changing value may be set to any value in a range of 5-15 cm. For example, the preset distance changing value may be set to 10 cm. The preset riding azimuth changing value may be set to any value in a range of 10-20 degree. For example, the preset riding azimuth changing value may be set to 15 degrees.

Furthermore, the control system 12 may be further configured to transmit the information on road surface to the navigation digital map system for marking, if it is determined that the road surface is a dumpy road surface, so that the navigation digital map system may avoid the bumpy road automatically when the vehicle (especially unmanned vehicle) performs road planning for the next time.

The road-surface detecting system provided by the present disclosure may reduce the detecting cost by detecting the bumping conditions of the road surface on which the vehicle is currently riding by the anti-knocking radar system, the G-Sensor system, the ADAS, and control system mounted on the vehicle.

### Fourth Embodiment

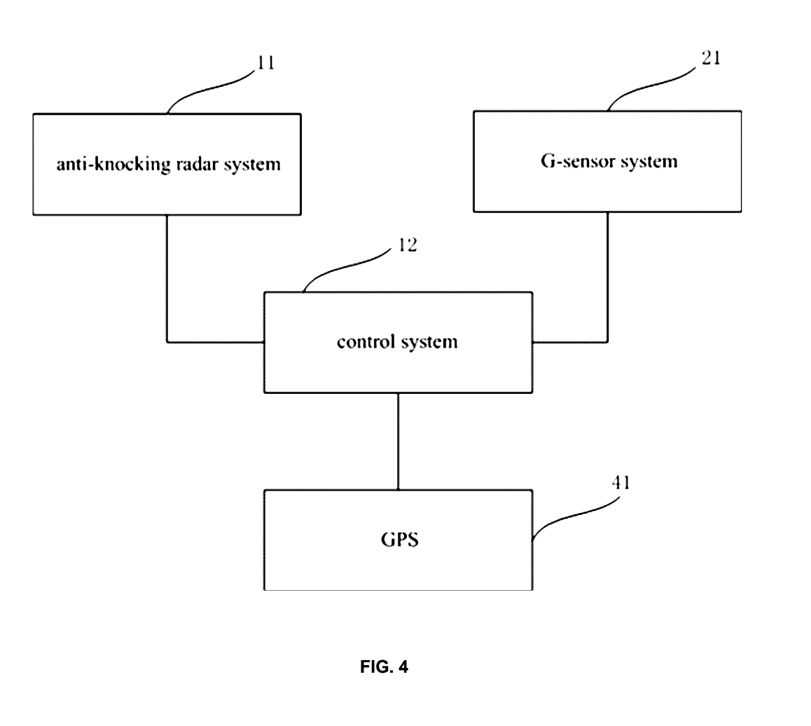

FIG. 4 is a structural diagram of another embodiment of the road-surface detecting system provided by the present disclosure.The road-surface detecting system of the embodiment of the present disclosure may be applicable to various kinds of vehicles. As shown in FIG. 4, the road-surface detecting system of the embodiment of the present disclosure may be an implementation for the road-surface detecting system of the embodiment shown in FIG. 2, and thus may additionally include a GPS (Global Positioning System) 41 on basis of embodiment shown in FIG. 2.

The GPS 41 may be configured to detect GPS data of vehicle and transmit the GPS data to the control system 12.

Correspondingly, the control system 12 may be further configured to determine whether or not the vehicle is in a turning state according to GPS data, and determine that the road surface is a bumpy road surface if change of the riding azimuth data is more than a preset riding azimuth data and the vehicle is not in aturning state.

More particularly, considering the riding azimuth of the vehicle may change when the vehicle is turning when the vehicle is riding on a normal road, a detection on whether or not the vehicle is in a turning state, so as to exclude the misjudgment caused by change of the riding azimuth when the vehicle is turning when the vehicle is riding on a normal road. The principle may be described as follows. The anti-knocking system 11 may measure the distance data for the distance from the chassis of the vehicle in real-time and the road surface and transmit the measured distance data to the control system 12. The G-Sensor system 12 may detect the riding azimuth data of the vehicle in real-time and transmit the riding azimuth data to the control system 12. The GPS 41 may detect the GPS data of vehicle in real-time and transmit the GPS data to the control system. The control system 12 may determine whether or not the vehicle is in a turning state according GPS data, and determinewhether or not the road surface is a bumpy road surface according to whether or not the received distance data changes and whether or not the change is more than a preset distance changing value and according to whether or not the received riding azimuth data changes and whether or not the change is more than a preset riding azimuth changing value when the vehicle is not in a turning state. The control system 12 may determine that the road surface is a bumpy road surface when the change of the received distance data is more than a preset distance changing value and the change of the received riding azimuth data is more than a preset riding azimuth changing value. Otherwise, it can be determined that the road surface is a non-bumpy road surface, i.e., a normal road surface. The anti-knocking radar system 11, the G-sensor system 21, and GPS 41 may be standard equipments for middle or top class vehicle and therefore it may be unnecessary to mount any additional detecting devices and the detecting cost may be reduced. More particularly, the preset distance changing value may be set to any value in a range of 5-15 cm. For example, the preset distance changing value may be set to 10 cm. The preset riding azimuth changing value may be set to any value in a range of 10-20 degree. For example, the preset riding azimuth changing value may be set to 15 degrees.

Furthermore, the control system 12 may be further configured to transmit the information on road surface to the navigation digital map system for marking, if it is determined that the road surface is a dumpy road surface, so that the navigation digital map system may avoid the bumpy road automatically when the vehicle (especially unmanned vehicle) performs road planning for the next time.

The road-surface detecting system provided by the present disclosure may reduce the detecting cost by detecting the bumping conditions of the road surface on which the vehicle is currently riding by the anti-knocking radar system, the G-Sensor system, the GPS, and control system mounted on the vehicle.

### Fifth Embodiment

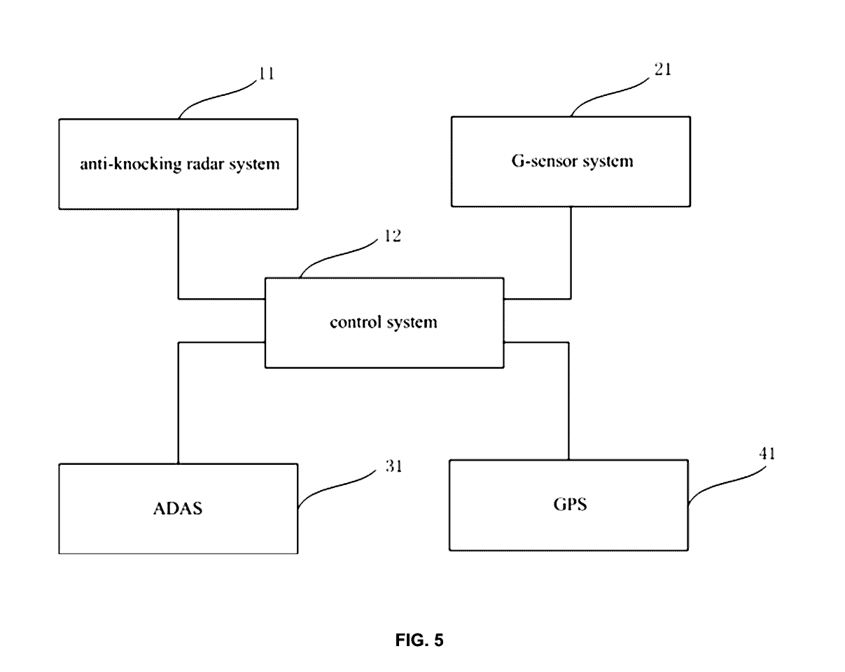

FIG. 5 is a structural diagram of another embodiment of the road-surface detecting system provided by the present disclosure. The road-surface detecting system of the embodiment of the present disclosure may be applicable to various kinds of vehicles. As shown in FIG. 5, the road-surface detecting system of the embodiment of the present disclosure may be an implementation for the road-surface detecting system of the embodiment shown in FIG. 2, and thus may additionally include an ADAS 31 and a GPS (Global Positioning System) 41 on basis of embodiment shown in FIG. 2.

The ADAS 31 may be configured to detect ADAS data of the vehicle and transmit the ADAS data to the control system 12.

The GPS 41 may be configured to detect GPS data of vehicle and transmit the GPS data to the control system 12.

Correspondingly, the control system 12 may be further configured to determine whether or not the vehicle is in a lane-switching or corner overtaking state according to ADAS data, and determine whether or not the vehicle is in a turning state according to GPS data, and determine that the road surface is a bumpy road surface if change of the riding azimuth data is more than a preset riding azimuth data and the vehicle is not in a lane-switching or corner overtaking state or aturning state.

More particularly, considering the riding azimuth of the vehicle may change when the vehicle is switching lane or making corner overtaking or turning when the vehicle is riding on a normal road, a detection on whether or not the vehicle is in a lane-switching or corner overtaking or turning state, so as to exclude the misjudgment caused by change of the riding azimuth when the vehicle is switching lane or making corner overtaking or turning when the vehicle is riding on a normal road. The principle may be described as follows. The anti-knocking system 11 may measure the distance data for the distance from the chassis of the vehicle in real-time and the road surface and transmit the measured distance data to the control system 12. The G-Sensor system 12 may detect the riding azimuth data of the vehicle in real-time and transmit the riding azimuth data to the control system 12. The ADAS 31 may detect ADAS data of the vehicle in real-time and transmit the ADAS data to the control system 12. The GPS 41 may detect the GPS data of vehicle in real-time and transmit the GPS data to the control system. The control system 12 may determine whether or not the vehicle is in a turning state according GPS data. The control system 12 may determine whether or not the vehicle is in a lane-switching or corner overtaking state according to ADAS data. The control system 12 may determine whether or not the road surface is a bumpy road surface according to whether or not the received distance data changes and whether or not the change is more than a preset distance changing value and according to whether or not the received riding azimuth data changes and whether or not the change is more than a preset riding azimuth changing value when the vehicle is not in a lane-switching or corner overtaking or turning state. The control system 12 may determine that the road surface is a bumpy road surface when the change of the received distance data is more than a preset distance changing value and the change of the received riding azimuth data is more than a preset riding azimuth changing value. Otherwise, it can be determined that the road surface is a non-bumpy road surface, i.e., a normal road surface. The anti-knocking radar system 11, the G-sensor system 21, ADAS 31, and GPS 41 may be standard equipments for middle or top class vehicle and therefore it may be unnecessary to mount any additional detecting devices and the detecting cost may be reduced. More particularly, the preset distance changing value may be set to any value in a range of 5-15 cm. For example, the preset distance changing value may be set to 10 cm. The preset riding azimuth changing value may be set to any value in a range of 10-20 degree. For example, the preset riding azimuth changing value may be set to 15 degrees.

Furthermore, the control system 12 may be further configured to transmit the information on road surface to the navigation digital map system for marking, if it is determined that the road surface is a dumpy road surface, so that the navigation digital map system may avoid the bumpy road automatically when the vehicle (especially unmanned vehicle) performs road planning for the next time.

The road-surface detecting system provided by the present disclosure may reduce the detecting cost by detecting the bumping conditions of the road surface on which the vehicle is currently riding by the anti-knocking radar system, the G-Sensor system, the ADAS, the GPS, and control system mounted on the vehicle.

### Sixth Embodiment

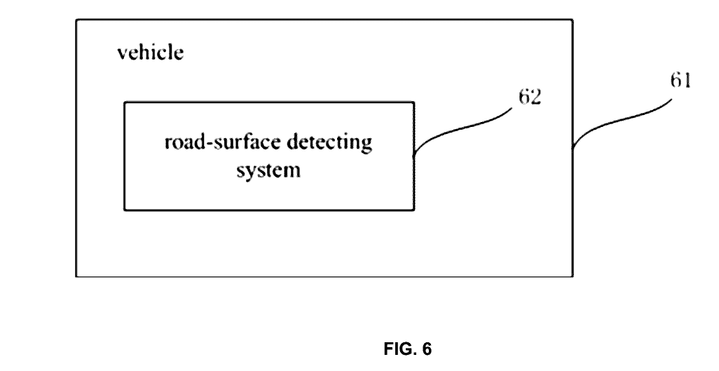

FIG. 6 is a structural diagram of an embodiment of the vehicle provided by the present disclosure. The vehicle 61 may be provided with the road-surface detecting system 62 of embodiment shown in one of FIG. 1-FIG. 5.

More particularly, The procedure for implementing its functions of the road-surface detecting system 62 of the vehicle 61 of the embodiment of the present disclosure may refer to the related description in embodiments shown in FIG. 1-FIG. 5 and may be omitted to avoid redundancy.

The road-surface detecting system provided by the present disclosure may reduce the detecting cost by detecting the bumping conditions of the road surface on which the vehicle is currently riding by the anti-knocking radar system, the G-Sensor system, the GPS, and control system mounted on the vehicle.

One skilled in the art would appreciate that all or a part of the steps for implementing the foregoing method embodiments may be implemented by hardware related to program instructions. Foregoing programs may be stored in computer-readable storage medium, and upon being executed, such programs may perform the steps including foregoing method embodiments; and examples of foregoing storage medium include ROM, RAM, CD-ROM, a magnetic tape, and the other types of storage mediums which may store the program codes.

It should be noted that the foregoing embodiments are merely used to illustrate the technical solution of the present disclosure, and not to limit the present disclosure. Although the present disclosure has been described in detail with reference to the foregoing embodiments, one skilled in the art would understand that the technical solutions recited in the foregoing embodiments may be modified or all or a part of the technical features may be replaced equally. These modifications and replacements are not intended to make corresponding technical solution depart from the scope of the technical solution of embodiments of the present disclosure.

What is claimed is:

1. A road-surface detecting system, comprising an anti-knocking radar system and a control system,
wherein the anti-knocking radar system is configured to measure distance data for the distance from the chassis of the vehicle and the road surface and transmit the distance data to the control system, and
the control system is configured to determine that the road is a bumpy road surface if change of the distance data is more than a preset distance changing value.

2. The road-surface detecting system according to claim 1, further comprising a G-sensor system configured to detect the riding azimuth data of the vehicle and transmit the riding azimuth data to the control system, and
the control system is further configured to determine that the road surface is a bumpy road surface if change of the riding azimuth data is more than a preset riding azimuth data and change of the distance data is more than a preset distance changing value.

3. The road-surface detecting system according to claim 2, further comprising an Advance Driver Assistant System, ADAS, configured to detect ADAS data of the vehicle and transmit the ADAS data to the control system 12, and
the control system is further configured to determine whether or not the vehicle is in a lane-switching or corner overtaking state according to ADAS data, and determine that the road surface is a bumpy road surface if change of the riding azimuth data is more than a preset riding azimuth data, the vehicle is not in a lane-switching or corner overtaking state and change of the distance data is more than a preset distance changing value.

4. The road-surface detecting system according to claim 2, further comprising a Global Positioning System, GPS, configured to detect GPS data of vehicle and transmit the GPS data to the control system, and
the control system is further configured to determine whether or not the vehicle is in a turning state according to GPS data, and determine that the road surface is a bumpy road surface if change of the riding azimuth data is more than a preset riding azimuth data and the vehicle is not in a turning state.

5. The road-surface detecting system according to claim 2, further comprising: anAdvance Driver Assistant System, ADAS, and a Global Positioning System, GPS,
the ADAS is configured to detect ADAS data of the vehicle and transmit the ADAS data to the control system,
the GPS is configured to detect GPS data of vehicle and transmit the GPS data to the control system, and
the control system is further configured to determine whether or not the vehicle is in a lane-switching or corner overtaking state according to ADAS data, and determine whether or not the vehicle is in a turning state according to GPS data, and determine that the road surface is a bumpy road surface, if change of the riding azimuth data is more than a preset riding azimuth data and the vehicle is not in a lane-switching or corner overtaking state or a turning state.

6. The road-surface detecting system according to claim 1, wherein the control system is further configured to transmit the information on road surface to the navigation digital map system for marking, if it is determined that the road surface is a dumpy road surface.

7. The road-surface detecting system according to claim 2, wherein the control system is further configured to transmit the information on road surface to the navigation digital map system for marking, if it is determined that the road surface is a dumpy road surface.

8. The road-surface detecting system according to claim 3, wherein the control system is further configured to transmit the information on road surface to the navigation digital map system for marking, if it is determined that the road surface is a dumpy road surface.

9. The road-surface detecting system according to claim 4, wherein the control system is further configured to transmit the information on road surface to the navigation digital map system for marking, if it is determined that the road surface is a dumpy road surface.

10. The road-surface detecting system according to claim 5, wherein the control system is further configured to transmit the information on road surface to the navigation digital map system for marking, if it is determined that the road surface is a dumpy road surface.

11. A vehicle, comprising the road-surface detecting system according to claim 1.

12. A vehicle, comprising the road-surface detecting system according to claim 2.

13. A vehicle, comprising the road-surface detecting system according to claim 3.

14. A vehicle, comprising the road-surface detecting system according to claim 4.

15. A vehicle, comprising the road-surface detecting system according to claim 5.

16. A vehicle, comprising the road-surface detecting system according to claim 6.

17. A vehicle, comprising the road-surface detecting system according to claim 7.

18. A vehicle, comprising the road-surface detecting system according to claim 8.

19. A vehicle, comprising the road-surface detecting system according to claim 9.

20. A vehicle, comprising the road-surface detecting system according to claim 10.
